(19) United States
(12) Patent Application Publication
(10) Pub. No.: US 2016/0258898 A1
(43) Pub. Date: Sep. 8, 2016

(54) Method for Operating a Chemically Sensitive Field-Effect Transistor

(71) Applicant: ROBERT BOSCH GMBH, Stuttgart (DE)

(72) Inventors: Juergen Graf, Stuttgart (DE); Francisco Hernandez Guillen, Stuttgart (DE)

(21) Appl. No.: 15/029,267

(22) PCT Filed: Oct. 6, 2014
(86) PCT No.: PCT/EP2014/071357

§ 371 Date: Apr. 14, 2016

(30) Foreign Application Priority Data
Oct. 15, 2013 (DE) 10 2013 220 849.9

(51) Int. Cl. G01N 27/414

(52) U.S. Cl. CPC G01N 27/4141

(57) ABSTRACT

The disclosure relates to a method for operating a chemically-sensitive field-effect transistor which comprises a gate connection. At least one electrical field is generated at least during operation of said field-effect transistor and in at least one section thereof such that movable ions present at least in one field-effect transistor region that adjoins said gate connection are enriched and retained in predefinable regions of said field-effect transistor.

### PRIOR ART

It is known to use semiconductor devices that are made for example of gallium nitride or silicon carbide for detecting a chemical substance contained in a fluid. Corresponding semiconductor devices may be formed as chemically sensitive field-effect transistors.

The focus of developments so far with respect to such chemically sensitive semiconductor devices has been in particular on their optimum design for detecting a specific chemical substance. In the case of such detection, typically a drift of the offset (known as “baseline drift”) is observed. Such an offset drift has various underlying causes with different time constants. These include in particular the generation, charging and discharging of interface states, the redistribution of free charge carriers from trapping sites, the removal of free charge carriers from trapping sites, the generation of defects, the presence of mobile charges in the dielectrics and the changes in the semiconductor, which for weak electrical loads are comparatively small. Altogether, an offset drift has the effect that spontaneously occurring, gas-induced detection signals may only be detectable by observing changes of detection signals, but quantitative measurements are not possible. There are no absolutely measuring gas sensors on the basis of the principle of chemically sensitive field-effect transistors.

### DISCLOSURE OF THE INVENTION

The subject of the invention is a method for operating a chemically sensitive field-effect transistor with a gate connection, characterized in that at least one electrical field is generated at least during the operation of the field-effect transistor at least in part of the field-effect transistor in such a way that movable ions present at least in a region of the field-effect transistor that adjoins the gate connection are enriched in predeterminable regions of the field-effect transistor and held there.

A movement of movable ions present in the chemically sensitive field-effect transistor, which may be induced for example by an ion drift and/or by diffusion, affects the detection signal I_{ds} in particular in the form of an offset drift. Therefore, the movable ions should not change their position within the field-effect transistor during the operation of the field-effect transistor. Furthermore, a degradation of the field-effect transistor brings about an offset drift, which should likewise be prevented.

With the method according to the invention, a movement of movable ions within the chemically sensitive field-effect transistor can be avoided to the greatest extent because the movable ions are held fixed at a specific location within the field-effect transistor by means of the electrical field. Furthermore, by choosing the strength of the respectively generated electrical field, the operating point of the chemically sensitive field-effect transistor can be set such that no degradation occurs. Consequently, with the method according to the invention, a drift of the offset is avoided to the greatest extent, so that, with a chemically sensitive field-effect transistor operated according to the invention, quantitative measurements or detections of at least one chemical substance contained in a fluid are possible over the entire service life of the chemically sensitive field-effect transistor.

Chemically sensitive field-effect transistors can be used for detecting at least one chemical substance in a fluid that is at a temperature in a range from 100° C. to 700° C., preferably from 300° C. to 500° C. The associated application of heat to a chemically sensitive field-effect transistor also has the effect of heating the field-effect transistor. Such heating of the chemically sensitive field-effect transistor is conducive to the mobility of the movable ions contained in the field-effect transistor, which is accompanied by the aforementioned disadvantageous consequences, in particular an offset drift. Therefore, the electrical field is preferably chosen such that no movement of movable ions and no degradation occur at the temperatures prevailing during the respective use of the chemically sensitive field-effect transistor.

Preferably, even before corresponding heating of a chemically sensitive field-effect transistor, the electrical field is generated in at least part of the field-effect transistor and maintained until the chemically sensitive field-effect transistor has cooled down again to a normal temperature when it is not in operation. As a result, diffusion of movable ions during heating up of the chemically sensitive field-effect transistor is avoided or an operating state of the chemically sensitive field-effect transistor is “frozen in” during cooling down of the chemically sensitive field-effect transistor.

Advantageously, the movable ions are drawn by means of the electrical field generated in at least part of the chemically sensitive field-effect transistor into a region of the chemically sensitive field-effect transistor from which they have no effects on a channel current between a source connection and a drain connection of the chemically sensitive field-effect transistor. The substances that are present in the respective fluid have a negligible influence on the movable ions that are held fixed in place by means of the electrical field because the movable ions are actively held by means of the electrical field.

When a chemically sensitive field-effect transistor is put into operation, first a specific ion distribution may be produced. After the production of this ion distribution, the operating point of the chemically sensitive field-effect transistor can be determined and an electrical field can be generated in at least part of the chemically sensitive field-effect transistor until a stable state of the chemically sensitive field-effect transistor at the respective operating temperature is achieved. The chemically sensitive field-effect transistor may cool down after its use as intended with the electrical field that is still present, for example to room temperature, in order specifically to “freeze in” the positions of the movable ions in order that there is no back diffusion of the movable ions into an undefined state. To operate the chemically sensitive field-effect transistor, an electrical voltage required for generating the electrical field suitable for keeping the movable ions at operating temperature is applied to the chemically sensitive field-effect transistor. The operating point should be chosen in particular such that no degradation occurs at the operating temperature of the chemically sensitive field-effect transistor as a result of the applied electrical field and there is a good signal-to-noise ratio and also good gas sensitivity. Preferably, only this fixed operating point is used for operating the chemically sensitive field-effect transistor.

A chemically sensitive field-effect transistor operated by the method according to the invention may be arranged together with a chemically sensitive field-effect transistor operated by another method on a common chip for checking the plausibility of measurement results.

According to an advantageous design, the electrical field is generated by applying an electrical voltage between a source connection and a drain connection of the field-effect transistor. As a result, movable cations in the region of the source connection and movable anions in the region of the drain connection can be enriched.

According to a further advantageous design, an electrical voltage is additionally applied between the source connection and the gate connection. As a result, the operating point of the chemically sensitive field-effect transistor can be set in such a way that a region of the characteristic of the field-effect transistor that is optimum for the respective evaluation concept is selected. In this case, the electrical fields generated should be kept so small that no degradation occurs at a desired operating temperature of the chemically sensitive field-effect transistor.

Also the subject of the invention is a system for detecting at least one chemical substance, having at least one chemically sensitive field-effect transistor and an electronic evaluation device connected by a communication link to the field-effect transistor, characterized by a device for generating at least one electrical field at least during the operation of the field-effect transistor in at least part of the field-effect transistor in such a way that movable ions present at least in a region of the field-effect transistor that adjoins the gate connection are enriched in predeterminable regions of the field-effect transistor and held there.

Correspondingly associated with this method are the advantages mentioned above with respect to methods.

An advantageous design provides that the device for applying an electrical voltage is formed between a source connection and a drain connection of the field-effect transistor, for which purpose the device is connected in an electrically conducting manner to the source connection and the drain connection.

In a further advantageous embodiment, the device for applying an additional electrical voltage is formed between the source connection and the gate connection, for which purpose the device is connected in an electrically conducting manner to the source connection and the drain connection.

The invention is explained below by way of example with reference to the appended figures on the basis of preferred exemplary embodiments, the features that are presented below being able both respectively by themselves and in various combinations with one another to represent an aspect of the invention. In the figures:

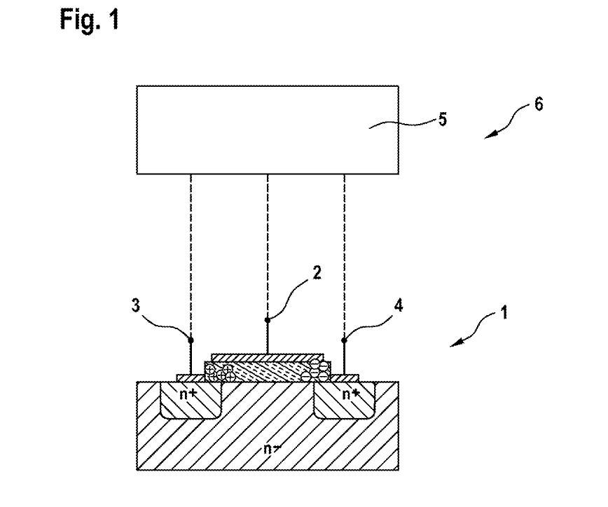

FIG. 1 shows a schematic representation of an exemplary embodiment of a state of a field-effect transistor that can be generated by means of the method according to the invention and

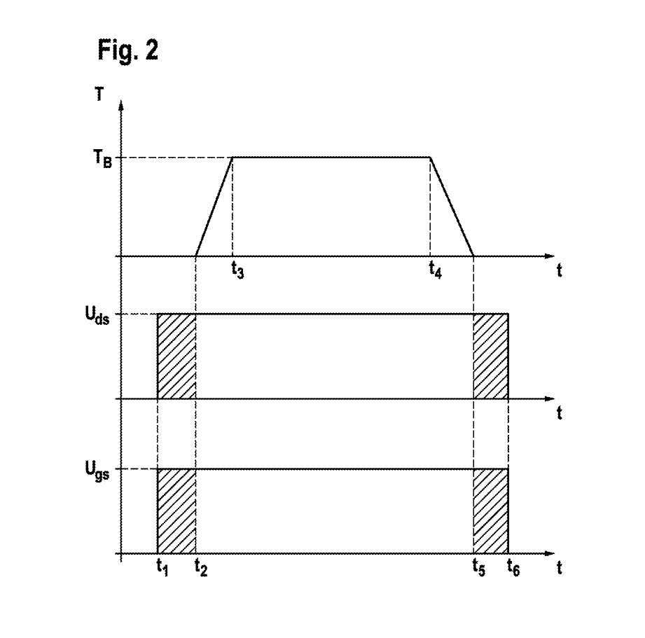

FIG. 2 shows a schematic representation of an activation of a field-effect transistor by means of an exemplary embodiment of a method according to the invention.

FIG. 1 shows a schematic representation of an exemplary embodiment of a state of a chemically sensitive field-effect transistor 1 that can be generated by means of the method according to the invention. The field-effect transistor 1 of a conventional type has a gate connection 2, a source connection 3 and a drain connection 4. Between the source connection 3 and a drain connection 4 there is an applied electrical voltage U_{ds}. Furthermore, between the source connection 3 and the gate connection 2, there is an applied electrical voltage U_{gs}. The electrical voltages U_{ds} and U_{gs} have the effect of generating in the field-effect transistor 1 an electrical field by which the movable cations in the region of the source connection 3 and the movable anions in the region of the drain connection 4 are enriched, as indicated in FIG. 1. The electrical field has the effect that the movable ions are kept in this defined configuration during the entire service life of the field-effect transistor.

Connected by a communication link to the chemically sensitive field-effect transistor 1 is an electronic evaluation device 5. In the embodiment shown, the evaluation device 5 forms a device that is formed for generating at least one electrical field at least during the operation of the field-effect transistor in at least part of the field-effect transistor in such a way that movable ions present at least in a region of the field-effect transistor that adjoins the gate connection are enriched in predeterminable regions of the field-effect transistor and held there. As a result, a system 6 for detecting at least one chemical substance is formed by the evaluation device 5 and the field-effect transistor 1.

The evaluation device is formed for applying an electrical voltage between the source connection 3 and a drain connection 4 of the field-effect transistor 1, for which purpose the evaluation device 5 is connected in an electrically conducting manner to the source connection 3 and the drain connection 4. Moreover, the evaluation device is formed for applying an additional electrical voltage between the source connection 3 and the gate connection 2, for which purpose the evaluation device 5 is connected in an electrically conducting manner to the source connection 3 and the drain connection 2.

FIG. 2 shows a schematic representation of an activation of a field-effect transistor 1 by means of an exemplary embodiment of a method according to the invention. Before the beginning of heating up the field-effect transistor 1, from the point in time t₂, a suitable electrical voltage U_{ds}>0 is applied between the source connection 3 and a drain connection 4 of the field-effect transistor 1 shown in FIG. 1 and an electrical voltage U_{gs}>0 is applied between the source connection 3 and the gate connection 2 by means of the evaluation device 5 shown in FIG. 1, thereby forming in the field-effect transistor 1 an electrical field by which the movable charges contained in the field-effect transistor 1 can be configured in a way corresponding to FIG. 1 over the entire service life of the field-effect transistor 1. The electrical voltages U_{ds} and U_{gs} and the electrical field thereby generated are maintained up to the point in time t₆. Maintaining the electrical voltages U_{ds} and U_{gs} in the time intervals t₁ to t₂ and t₅ to t₆ is optional. In principle, it would be sufficient to maintain the electrical voltages U_{ds} and U_{gs} in the time interval t₂ to t₅. The field-effect transistor 1 is heated up to its operating temperature T_{B} in the time interval t₂ to t₃ and cooled down in the time interval t₄ to t₅.

1. A method for operating a chemically sensitive field-effect transistor with having a gate connection, the method comprising:
generating at least one electrical field at least during operation of the field-effect transistor at least in part of the field-effect transistor, the at least one electrical field being configured to enrich movable ions in a predetermined region of the field-effect transistor and hold the movable ions in the predetermined region, the movable ions being present at least in a region of the field-effect transistor that adjoins the gate connection.

2. The method as claimed in claim 1, the generating of the at least one electrical field comprising:
applying a first electrical voltage between a source connection of the field-effect transistor and a drain connection of the field-effect transistor.

3. The method as claimed in claim 2, further comprising:
applying a second electrical voltage between the source connection and the gate connection.

4. A system for detecting at least one chemical substance, the system comprising:
at least one chemically sensitive field-effect transistor; an electronic evaluation device connected by a communication link to the field-effect transistor; and
a device configured to generate at least one electrical field at least during operation of the field-effect transistor in at least part of the field-effect transistor, the at least one electrical field being configured to enrich movable ions in a predetermined region of the field-effect transistor and hold the movable ions in the predetermined region, the movable ions being present at least in a region of the field-effect transistor that adjoins the gate connection.

5. The system as claimed in claim 4, wherein the device is connected in an electrically conducting manner to a source connection of the field-effect transistor and a drain connection of the field-effect transistor, the device being configured to apply a first electrical voltage between the source connection and the drain connection to generate the at least one electrical field.

6. The system as claimed in claim 5, wherein the device is connected in an electrically conducting manner to the source connection and the gate connection, the device being configured to apply a second electrical voltage between the source connection and the gate connection.
